(19) United States
(12) Patent Application Publication
(10) Pub. No.: US 2002/0186204 A1
(43) Pub. Date: Dec. 12, 2002

(54) Apparatus for sensing location of object on screen

(76) Inventor: Buhm Kim, Kyunggi-do (KR)

Correspondence Address: MARSHALL, GERSTEIN & BORUN, 6300 SEARS TOWER, 233 SOUTH WACKER, CHICAGO, IL, 60606-6357, US

(21) Appl. No.: 10/033,681

(22) Filed: Dec. 27, 2001

(30) Foreign Application Priority Data
Jun. 8, 2001 (KR) 2001-31984

(51) Int. Cl. G09G 5/08

(52) U.S. Cl. 345/158

(57) ABSTRACT

There is provided an apparatus for sensing the location of an object on a screen. The object location sensing apparatus includes an input device and a main body. A transmitter is installed in the input device, for detecting a video signal at a position pointed by an optical system on the screen, transmitting the video signal as an infrared signal, and transmitting key data as an RF signal. A receiver is provided to the main body, for receiving the infrared signal and the RF signal from the transmitter and detecting the position pointed by the optical system on the screen by comparing the reception timing of the infrared signal with the output timing of the present video signal output to the screen.

This application claims priority to an application entitled “Apparatus for Sensing Location of Object on Screen” filed in the Korean Industrial Property Office on Jun. 8, 2001 and assigned Serial No. 2001-31984, the contents of which are hereby incorporated by reference.

### BACKGROUND OF THE INVENTION

1. Field of the Invention

The present invention relates generally to an apparatus for sensing the location of an object on the monitor of a PC (Personal Computer), a TV, or a video projector, and in particular, to an apparatus for sensing a target position toward which a gun player points a gun in an electronic game (hereinafter, referred to as a game) device.

2. Description of the Related Art

When playing a game through a computer system, a mouse, joystick, or keyboard is usually used as an input device. The mouse or joystick moves an object or a background image on a screen. The keyboard inputs generally character information and in some cases, it can move an object or a background image by directional keys.

However, these input devices have limitations in playing a lively game with some electronic game programs. Such game programs include, for example, a shooting game. The shooting game requires fast movement of an internal pointer toward an abruptly emerging target to shoot it. In particular, the shooting game is based on uncertainty about whether the gun aims at the target correctly. Therefore, there is a need for an input device that can move an internal pointer toward the point of the gun.

A pistol- or rifle-shaped input device can be considered to play a shooting game in a computer-aided or a TV-using game device. An LED (Light Emitting Diode) is mounted to the muzzle of the pistol- or rifle-shaped input device and an optical diode array is installed in a screen, so that the LED transmits an optical signal when a gun player pulls the trigger of the input device and an optical diode receives the optical signal. The shortcoming of this input device is, however, that installation of the optical diode array in the screen increases the price of the input device.

As an alternative, an integrated device of a joystick and the pistol- or rifle-shaped input device has been developed. Referring to FIG. 1, a conventional shooting game device has a position sensor 120 attached fixedly to a pistol-shaped input device 110. When the gun aims up, down, left, or right, the position sensor 120 senses the motion and detects the position pointed by the gun on a screen 130. However, the conventional shooting game device has limitations in effecting real shooting because the pistol-shaped input device 110 can make only horizontal and vertical motions with aid of the position sensor 120. Moreover, in the nature of shooting games, a game player abruptly moves the pistol-shaped input device 110 in many cases. Then significant physical stress is applied to the joint portion between the pistol-shaped input device 110 and the position sensor 120, which is highly likely to cause mechanical abrasion and breakage to the game device.

### SUMMARY OF THE INVENTION

The present invention provides an improved method and apparatus for sensing the location of an object on a screen. The object location sensing apparatus includes an input device and a main body. A transmitter is installed in the input device, for detecting a video signal at a position pointed by an optical system on the screen, transmitting the video signal as an infrared signal, and transmitting key data as an RF signal. A receiver is provided to the main body, for receiving the infrared signal and the RF signal from the transmitter and detecting the position pointed by the optical system on the screen by comparing the reception timing of the infrared signal with the output timing of the present video signal output to the screen.

### BRIEF DESCRIPTION OF THE DRAWINGS

The features and advantages of the present invention will become more apparent from the following detailed description when taken in conjunction with the accompanying drawings in which:

FIG. 1 is a perspective view of a conventional computer-aided shooting game device;

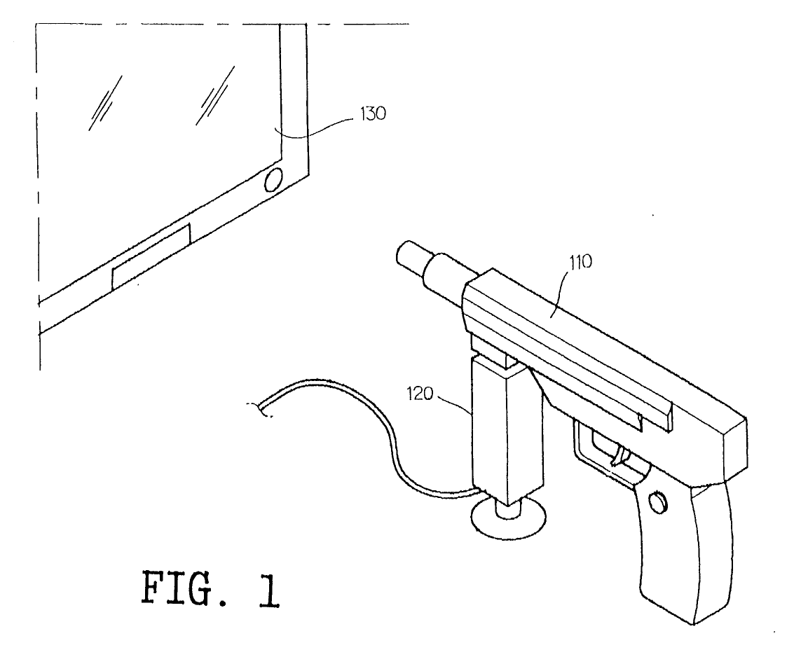

FIG. 2 is a block diagram of a computer-aided shooting game device according to an embodiment of the present invention;

FIG. 3 is a perspective view of the computer-aided shooting game device according to the embodiment of the present invention; and

FIG. 4 illustrates an example of installation of manipulation keys on a keypad of a rifle-shaped input device in the computer-aided shooting game device according to the embodiment of the present invention.

### DETAILED DESCRIPTION OF THE PREFERRED EMBODIMENT

A preferred embodiment of the present invention will be described hereinbelow with reference to the accompanying drawings. In the following description, well-known functions or constructions are not described in detail since they would obscure the invention in unnecessary detail. The following description is made on an exemplary case where an object location sensing apparatus according to the present invention is applied to a computer-aided shooting game.

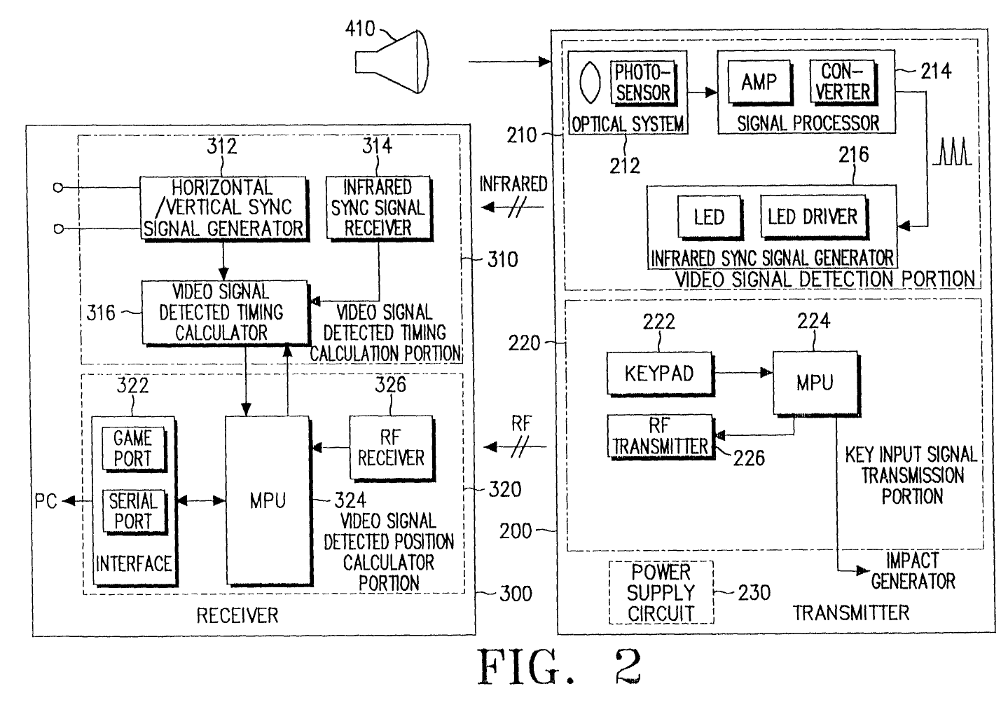

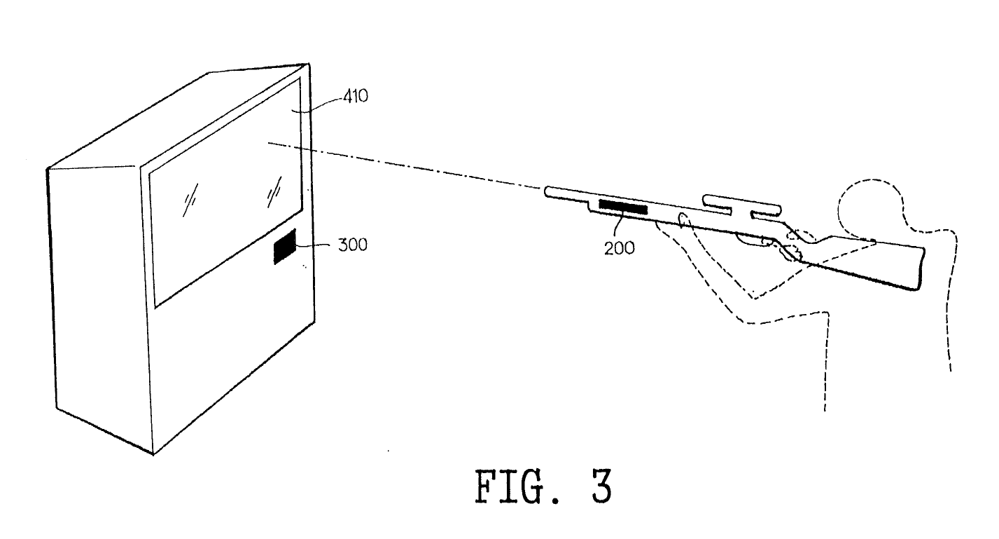

FIG. 2 is a block diagram of a computer-aided shooting game device according to an embodiment of the present invention and FIG. 3 is a perspective view of the computer-aided shooting game device. Referring to FIGS. 2 and 3, the computer-aided shooting game device is comprised of a rifle-shaped input device and a main body. The rifle-shaped input device is connected wirelessly to the main body. The rifle-shaped input device has a transmitter 200 and the main body, a receiver 300.

The transmitter 200 detects a video signal at a location pointed by an optical system 212 on a screen 410 and transmits the video signal as an infrared signal. The transmitter 200 also transmits key input data including data generated by pulling the trigger of the rifle-shaped input device as an RF signal. The receiver 300 is connected to a PC or a TV, for receiving the infrared signal and RF signal from the transmitter 200, detects the location of the optical system 212 on the screen 410 by comparing the infrared signal detection timing with the output timing of the present video signal onto the screen 410, and senses key input data including the data input generated by pulling the trigger of the rifle-shaped input device.

To describe the structures of the transmitter 200 and the receiver 300 in more detail, the transmitter 200 includes a video signal detection portion 210 for detecting a video signal at the location pointed by the optical system 212 on the screen 410 and transmitting the video signal as an infrared signal, and a key input signal transmission portion 220 for transmitting key input data including data input generated by pulling the trigger of the rifle-shaped input device as an RF signal.

The video signal detection portion 210 has the optical system 212, a signal processor 214, and an infrared sync signal generator 216. The optical system 212, installed at the end of the gun barrel and including a lens and a photo-sensor, receives a video signal from the location pointed by the rifle-shaped input device on the screen 410 and converts the input optical signal to an electrical signal. The signal processor 214 includes an amplifier and a converter, for amplifying the signal received from the optical system 212 and converting the amplified signal to a signal with short rising and falling edge timing. The infrared sync signal generator 216, including an LED and an LED driver, generates an infrared sync signal for the signal received from the signal processor 214. The lens of the optical system 212 can be designed to receive a signal from a point of an appropriate size at a predetermined position, for example, 2 to 4 m away.

The video signal detection portion 210 detects a video signal at a position pointed by the optical system 212 on the screen 410 by checking the scanning states of a plurality of video scan lines at the position in each picture frame and outputs the video signal as an infrared signal.

The key input signal transmission portion 220 includes the trigger of the rifle-shaped input device and a plurality of manipulation keys. It is comprised of a keypad 222 for generating key data in correspondence with key input from a user, an MPU (Main Processing Unit) 224 for providing overall control to the transmitter 200 and controlling wireless transmission of key data generated from the keypad 222, and an RF transmitter 226 for wirelessly transmitting input key data as an RF signal under the control of the MPU 224. The manipulation keys of the keypad 222 except the trigger can be disposed appropriately at a position of a barrel cover where the left hand of the user is disposed.

The thus-constituted key input signal transmission portion 220 wirelessly transmits key data from the trigger and the manipulation keys to the receiver 300. The MPU 224 outputs an operation control signal to a predetermined impact generator (not shown) installed at the gunstock of the rifle-shaped input device in order to generate the effect of real shooting when the user pulls the trigger.

The transmitter 200 may further include a power supply circuit 230 for power management. That is, the rifle-shaped input device has a power supply like a battery and the power supply circuit 230 senses the battery voltage of the power supply and displays a visual signal according to the voltage level through the LED.

The receiver 300 is divided largely into a video signal detected timing calculation portion 310 and a video signal detected position calculation portion 320. The video signal detected timing calculation portion 310 receives an infrared signal from the infrared sync signal generator 216 of the transmitter 200 and the present video signal output to the screen 410 and calculates the time required from the output time point of the frame of a video signal detected by the video signal detection portion 210 to the detected time point of the video signal by comparing the generated timing of the infrared signal with the output timing of the present video signal.

The video signal detected position calculation portion 300 detects the position pointed by the optical system 212 on the screen 410 based on the calculated time, transmits the detected position information to an external device like a PC, receives an RF signal from the key input signal transmission portion 220, and detects key input including key data generated by pulling the trigger of the transmitter 200.

In more detail, the video signal detected timing calculation portion 310 is comprised of a horizontal/vertical sync signal generator 312 for receiving the present video signal output to the screen 410 and generating a horizontal/vertical sync signal for the horizontal/vertical sync signal of the video signal, an infrared sync signal receiver 314 for receiving an infrared sync signal from the transmitter 200 and generating an input signal for the infrared sync signal, and a video signal detected timing calculator 316 for calculating the time from the output time of a video signal frame to the detected time of the video signal by comparing the generated timing of the horizontal/vertical sync signal with that of the input signal.

The video signal detected timing calculator 316 may further have a first counter for counting according to an input horizontal sync signal and a second counter for counting according to an input vertical sync signal. Every time the horizontal sync signal is input, the first counter is reset to 0 and every time the vertical sync signal is input, the second counter is reset to 0. Upon input of the infrared sync signal, the first and second counters stop counting and output their count values by which the detection time of the video signal in the video signal detection portion 210 is calculated. That is, the time required to scan the video signal at the position pointed by the optical system 212 in a corresponding frame is calculated from the count values. Based on the scan time is calculated the position of the optical system 212 on the screen 410 where the video signal is detected.

Positioning a video signal on a screen is applied to the so-called light pen technology.

The video signal detected position calculation portion 320 of the receiver 300 is comprised of an RF receiver 326, an interface 322, and an MPU 324. The RF receiver 326 receives an RF signal from the key input signal transmission portion 220 and feeds it to the MPU 324. The interface 322 has a game port with a game portion emulation circuit for connecting to the game port of a PC and a serial port with an RS232 interface circuit, for connecting to the serial port of the PC, and thus interfaces data with the PC. An operating power voltage for the receiver 300 can be received from the external PC through the game port of the interface 322. The MPU 324, a controller for providing overall control to the receiver 300, senses the manipulation of the trigger of the rifle-shaped input device by receiving a signal from the RF receiver 326, detects the position pointed by the optical system 212 on the screen 410 based on the calculated time received from the video signal detected timing calculator 316 when the trigger is pulled, and transmits the position information to the external device like a PC via the interface 322. In addition, the MPU 324 feeds key data received from the key input signal transmission portion 220 to the external PC via the interface 322.

Upon input of key data generated by pulling the trigger, the MPU 324 outputs an operation control signal to operate the video signal detected timing calculator 316 so as to calculate the detected time of a video signal at the position pointed by the optical system 212 on the screen 410 in the video signal detection portion 210.

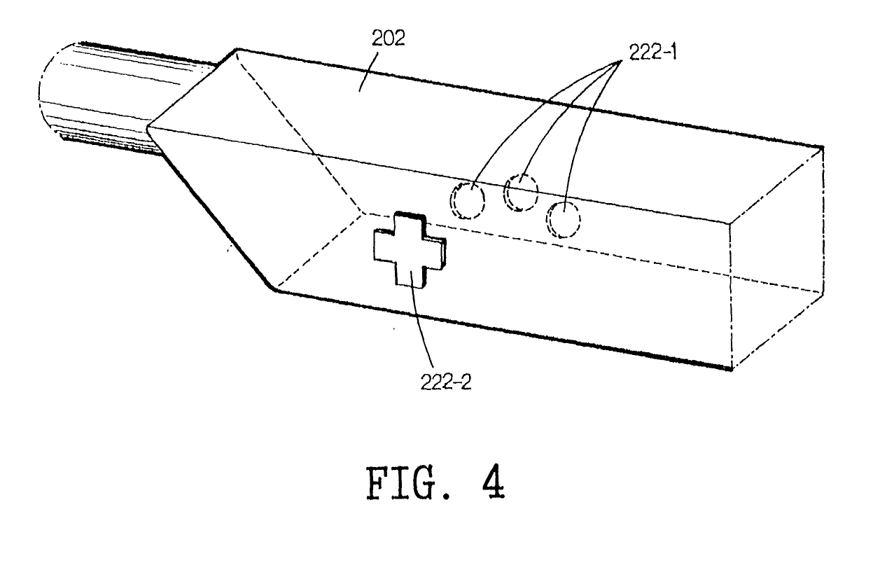

Meanwhile, the keypad 222 of the transmitter 200 can have various keys, which are installed at an easy-manipulating position. This will be described referring to FIG. 4.

FIG. 4 illustrates an example of arrangement of keys in the keypad of the rifle-shaped input device in the computer-aided shooting game device according to the embodiment of the present invention. Referring to FIG. 4, manipulation keys 222-1 and 222-2 in the keypad 222 except the trigger are disposed at positions of a barrel cover 202 where the left hand of the user touches. At a position of the barrel cover 202 where the left thumb is supposed to touch is installed a directional key 222-2. A plurality of motion setting keys 222-1 may be disposed at a position where the left index and ring fingers touch. The directional key 222-2 directs a unit (or a background image) up, down, left, and right on the screen and the motion setting keys 222-1 set motions of the unit, including sitting, jumping, lying-down and the like (or movement of the background image according to the motions).

As described above, the input device of the present invention, due to its wireless operation, can reduce damage that would be done if it were mechanically installed at the game device body as in the conventional game device. Since there is no need for arranging an optical diode array in a screen, an object can be located from the screen with low cost. Furthermore, the real shooting effect increases interest in an electronic game. The present invention can be applied widely to military shooting simulation and non-contact light pens as well as shooting game devices.

While the invention has been shown and described with reference to a certain preferred embodiment thereof, it is a mere exemplary application. Aside from a rifle, for example, the input device can be another kind of simulated weapon such as a pistol. Therefore, it will be understood by those skilled in the art that various changes in form and details may be made therein without departing from the spirit and scope of the invention as defined by the appended claims.

What is claimed is:

1. An apparatus for sensing the location of an object on a screen, comprising:
a remote input device having a transmitter for detecting a video signal at a position pointed by an optical system on the screen, transmitting the video signal as an infrared signal, and transmitting key data as an RF signal; and
a main body having a receiver for receiving the infrared signal and the RF signal from the transmitter and detecting the position pointed by the optical system on the screen by comparing the reception timing of the infrared signal with the output timing of the present video signal output to the screen.

2. The apparatus of claim 1, wherein the transmitter comprises:
a video signal detection portion for detecting the video signal at the position pointed by the optical system on the screen and transmitting the video signal as an infrared signal; and
a key input signal transmission portion for wirelessly transmitting key input data of the input device.

3. The apparatus of claim 2, wherein the video signal detection portion comprises:
the optical system disposed at the end of the input device and having a lens and a photo-sensor, for receiving the video signal at the position pointed by the optical system on the screen and converting the received optical signal to an electrical signal;
a signal processor having an amplifier and a converter, for amplifying the signal received from the optical system and converting the amplified signal to a signal with short rising and falling edge timing; and
an infrared sync signal generator having an infrared LED and an infrared LED driver, for generating an infrared sync signal for the signal received from the signal processor.

4. The apparatus of claim 2, wherein the key input signal transmission portion comprises:
a keypad having a plurality of manipulation keys, for generating key data corresponding to key input;
a transmitter controller for providing overall control to the transmitter and controlling wireless transmission of key data received from the keypad; and
an RF transmitter for wirelessly transmitting received key data under the control of the transmitter controller.

5. The apparatus of claim 1, wherein the receiver comprises:
a video signal detected timing calculation portion for receiving the infrared signal from the transmitter and the present video signal output to the screen and calculating the time from the output time of the frame of the video signal detected in the video signal detection portion to the detected time of the video signal by comparing the generated timing of the infrared signal with the output timing of the present video signal output to the screen; and
a video signal detected position calculation portion for detecting the position pointed by the optical system on the screen on the time calculated by the video signal detected timing calculation portion, and outputting the detected timing information and key data information included in the RF signal received from the transmitter to an external device.

6. The apparatus of claim 5, wherein the video signal detected timing calculation portion comprises:
a horizontal/vertical sync signal generator for receiving the present video signal output to the screen and generating a horizontal/vertical sync signal for the horizontal/vertical sync signal of the video signal;
an infrared sync signal receiver for receiving an infrared sync signal from the transmitter and generating an input signal for the infrared sync signal; and
a video signal detected timing calculator for receiving the horizontal/vertical sync signal received from the horizontal/vertical sync signal generator and the input signal received from the infrared sync signal receiver, and calculating the time required from the output time of the frame of the video signal detected in the video signal detection portion to the detected time of the video signal by comparing the generation timing of the horizontal/vertical sync signal with the generation timing of the input signal.

7. The apparatus of claim 5, wherein the video signal detected position calculation portion comprises:
an RF signal receiver for receiving the RF signal from the key input signal transmission portion;
an interface having a game port for connecting to a game port of the external device and a serial port for connecting to a serial port of the external device; and
a receiver controller for providing overall control to the receiver, sensing key data of the input device by receiving a signal from the RF receiver, detecting the position pointed by the optical system on the screen by receiving the time calculated by the video signal detected timing calculator, and transmitting the detected position information to the external device via the interface.

8. An apparatus for sensing the location of an object on a screen, comprising:
a remote gun-shaped input device having a transmitter that includes a video signal detected portion for detecting a video signal at a position pointed by an optical system on the screen and transmitting the video signal as an infrared signal, and a key input signal transmission portion for transmitting key data as an RF signal; and
a game device body having a receiver that includes a video signal detected timing calculation portion for receiving the infrared signal from the transmitter and the present video signal output to the screen and calculating the time from the output time of the frame of the video signal detected in the video signal detection portion to the detected time of the video signal by comparing the generated timing of the infrared signal with the output timing of the present video signal output to the screen, and a video signal detected position calculation portion for detecting the position pointed by the optical system on the screen on the time calculated by the video signal detected timing calculation portion, and outputting the detected timing information and key data information included in the RF signal received from the transmitter to an external device.

9. The apparatus of claim 8, wherein the video signal detection portion comprises the optical system disposed at the end of the input device and having a lens and a photo-sensor, for receiving the video signal at the position pointed by the optical system on the screen and converting the received optical signal to an electrical signal, a signal processor having an amplifier and a converter, for amplifying the signal received from the optical system and converting the amplified signal to a signal with short rising and falling edge timing, and an infrared sync signal generator having an infrared LED and an infrared LED driver, for generating an infrared sync signal for the signal received from the signal processor, and wherein the key input signal transmission portion comprises a keypad having a plurality of manipulation keys, for generating key data corresponding to key input, a transmitter controller for providing overall control to the transmitter and controlling wireless transmission of key data received from the keypad, and an RF transmitter for wirelessly transmitting received key data under the control of the transmitter controller.

10. The apparatus of claim 9, wherein the keypad includes a directional key at an end of a barrel cover of the gun-shaped input device and a plurality of motion setting keys at the other end.

11. The apparatus of claim 9, wherein the video signal detected timing calculation portion comprises a horizontal/vertical sync signal generator for receiving the present video signal output to the screen and generating a horizontal/vertical sync signal for the horizontal/vertical sync signal of the video signal, an infrared sync signal receiver for receiving an infrared sync signal from the transmitter and generating an input signal for the infrared sync signal, and a video signal detected timing calculator for receiving the horizontal/vertical sync signal received from the horizontal/vertical sync signal generator and the input signal received from the infrared sync signal receiver, and calculating the time required from the output time of the frame of the video signal detected in the video signal detection portion to the detected time of the video signal by comparing the generation timing of the horizontal/vertical sync signal with the generation timing of the input signal, and wherein the video signal detected position calculation portion comprises an RF signal receiver for receiving the RF signal from the key input signal transmission portion, an interface having a game port for connecting to a game port of the external device and a serial port for connecting to a serial port of the external device, and a receiver controller for providing overall control to the receiver, sensing key data of the input device by receiving a signal from the RF receiver, detecting the position pointed by the optical system on the screen by receiving the time calculated by the video signal detected timing calculator, and transmitting the detected position information to the external device via the interface.

12. A method of sensing the location of an object on a video screen using a computer-aided shooting game device, the shooting game device having a transmitter with a sensor, and a receiver, the method comprising the steps of:
detecting a portion of a first video signal at a position on the video screen at which the sensor is directed;
transmitting the portion of the first video signal from the transmitter to the receiver;
receiving the portion of the first video signal at the receiver;
receiving a second video signal displayed on the video screen at the receiver;
comparing the timing of the portion of the first video signal to the timing of the second video signal to determine a calculated time; and
determining the position on the video screen of the portion of the first video signal based on the calculated time.

13. A method as defined in claim 12, wherein the transmitting step of comprises the steps of:
converting the portion of the first video signal to an infrared signal
transmitting the infra-red signal to the receiver.

14. A method as defined in claim 12, further comprising the step transmitting the position on the video screen to an external processing device.

15. A method as defined in claim 12, wherein the transmitter further comprises an input device including a trigger adapted to move to a firing position, the method further comprising the steps of:
detecting movement of the trigger to the firing position;
transmitting data indicative of the timing of the movement of the trigger to the firing position from the transmitter to the receiver.

16. A method as defined in claim 13, wherein the data indicative of the timing of the movement of the trigger to the firing position is transmitted from the transmitter to the receiver as a radio-frequency signal.

17. A method as defined in claim 16, further comprising the step of transmitting the data indicative of the timing of the movement of the trigger to the firing position to an external processing device.
